(19) United States
(12) Patent Application Publication
(10) Pub. No.: US 2008/0123842 A1
(43) Pub. Date: May 29, 2008

(54) Association of a cryptographic public key with data and verification thereof

(75) Inventor: Seppo Pohja, Tampere (FI)

Correspondence Address: SQUIRE, SANDERS & DEMPSEY L.L.P., 8000 TOWERS CRESCENT, 14TH FLOOR, TYSONS CORNER, VA, 22182-2700, US

(73) Assignee: Nokia Corporation

(21) Appl. No.: 11/592,261

(22) Filed: Nov. 3, 2006

(51) Int. Cl. H04L 9/30; H04L 9/28

(52) U.S. Cl. 380/44; 380/30

(57) ABSTRACT

The invention allows a creator of a key pair—a public and a private key—to associate user data with the public key in such a way that verification data needed to cryptographically verify the association can be made public without compromising the key pair. An integer for use as a public exponent in the public key is derived such that it is a function of the user data to be associated with the public key.

### BACKGROUND OF THE INVENTION

1. Field of the Invention

The invention relates to cryptography. In particular, the invention relates to a novel and improved association of a cryptographic public key with data.

2. Description of the Related Art

Modern computer-assisted cryptographic techniques can be categorized into two main areas: symmetric and asymmetric. Symmetric cryptographic techniques use the same key (typically called a secret key) to both encrypt and decrypt a message. Often, asymmetric cryptographic techniques use a first key (typically called a public key) to encrypt a message and a second key (typically called a private key) to decrypt the message. Asymmetric cryptographic techniques are also called public key techniques. However, there are other ways to use the public key and the private key as well. For example, in digital signing, the private key can be used to digitally sign a document and the public key can be used by anyone to verify that the owner of the private key executed the signing.

Symmetric cryptographic techniques include Data Encryption Standard (DES), Advanced Encryption Standard (AES), and their variants. Asymmetric cryptographic techniques include Diffie-Hellman technique, RSA technique (Rivest, Shamir, Adleman), ElGamal technique, and their variants.

In public key cryptography, the public key and the private key (typically called a key pair) are mathematically related. Furthermore, the public key and the private key are selected in such a way that it is not feasible to deduce the private key of a pair given the public key.

Therefore, the public key is typically distributed widely while the private key is kept secret. As a result, typically anyone can get a hold of the public key and encrypt a message to be sent to the owner of the key pair using the public key. However, only the owner can decrypt the message using the private key. Correspondingly, only the owner of the key pair can digitally sign the message (or another document) with the private key while typically anyone can verify the digital signature with the public key.

Since the public keys are often widely distributed, a mechanism is needed to bind the identity of the owner of the key pair to the distributed public key so that anyone can verify that a public key truly belongs to an individual it is claimed to belong to. Otherwise, anyone could publish a different public key (for which he knows the related private key) falsely claiming that it is the above individual's public key.

Today, public key certificates are used to provide such a mechanism. The public key certificate may comprise a public key, and e.g. identity data (e.g. name, address, telephone number, electronic mail address, and so forth) identifying the owner of the public key. The public key and the associated data, such as e.g. identity data, are cryptographically bound together with a digital signature belonging to a trusted third party. Often, the trusted third party is a certificate authority (CA). The certificate authority may be e.g. a commercial one, a governmental one, or an institutional one. Common commercial certificate authorities include VeriSign and Thawte. In the art, a public key certificate that includes key owner identity data is often called an identity certificate.

However, there are significant drawbacks associated with the use of public key certificates. If a private key associated with the public key of a public key certificate gets compromised, the public key certificate must be revoked. Traditionally, revocation was performed via a certificate revocation list maintained by the certificate authority. The certificate revocation list comprises a list of certificates which e.g. have been revoked, are no longer valid, and/or should not be relied upon by any system user.

Today, Online Certificate Status Protocol (OCSP) has mostly superseded certificate revocation lists. OCSP allows querying certificate status information when a user attempts to access a resource, such as a server.

However, the use of certificate revocation lists and OCSP requires that the owner of the key pair is aware that the private key has been compromised in order to be able to inform the certificate authority about it. Yet, a long period of time might pass before the owner becomes aware of this during which time a malicious third party can utilize the compromised key pair to launch various attacks, such as e.g. identity theft, character assassination, illegal resource access, etc. Furthermore, to be effective, certificate status information must be readily available to anyone who needs it, and it must be updated frequently. Yet, since there are always delays due to e.g. processing of incoming revocation requests, certificate status information cannot be kept up-to-date in real time. In other words, currently there is no way to verify with any real certainty that a distributed public key actually belongs to its alleged owner.

### SUMMARY OF THE INVENTION

A first aspect of the present invention is a method in which a first prime number P and a second prime number Q are generated. Furthermore, an integer E is randomly derived as a function of a given random input number a and a bit string representation u of given user data. Furthermore, in response to the derived integer E and a product (P−1)(Q−1) being relatively prime and further in response to the derived integer E both exceeding 1 and remaining below the product (P−1)(Q−1), a cryptographic key pair is generated which comprises a private key and an associated public key with the derived integer E used as a public exponent in the public key in order to create a cryptographic association between the public key and the given user data.

A second aspect of the present invention is a method in which predetermined user data is obtained, and a public key of a cryptographic key pair is obtained which public key comprises a predetermined integer E as a public exponent and which public key allegedly has a cryptographic association with the predetermined user data, and a predetermined random input number a is obtained, and a predetermined function ƒ is obtained which predetermined function ƒ was used to randomly derive the obtained public exponent E from given input values. Furthermore, ƒ(u,a) is calculated using the obtained function ƒ with the obtained random input number a and a bit string representation u of the obtained predetermined user data as the given input values. Furthermore, it is determined that the alleged cryptographic association between the obtained predetermined user data and the obtained public key is valid in response to the calculated ƒ(u,a) equaling the obtained public exponent E. Furthermore, it is determined that the alleged cryptographic association between the obtained predetermined user data and the obtained public key is invalid in response to the calculated ƒ(u,a) not equaling the obtained public exponent E.

A third aspect of the present invention is an apparatus that comprises a prime number generator configured to generate a first prime number P and a second prime number Q. The apparatus of the third aspect further comprises a random integer generator configured to randomly derive an integer E as a function of a given random input number a and a bit string representation u of given user data. The apparatus of the third aspect further comprises a key pair generator configured to generate, in response to the derived integer E and a product (P−1)(Q−1) being relatively prime and further in response to the derived integer E both exceeding 1 and remaining below the product (P−1)(Q−1), a cryptographic key pair comprising a private key and an associated public key with the derived integer E used as a public exponent in the public key in order to create a cryptographic association between the public key and the given user data.

A fourth aspect of the present invention is an apparatus that comprises an obtainer configured to obtain predetermined user data, and to obtain a public key of a cryptographic key pair which public key comprises a predetermined integer E as its public exponent and which public key allegedly has a cryptographic association with the predetermined user data, and to obtain a predetermined random input number a, and to obtain a predetermined function ƒ used to randomly derive the obtained public exponent E from given input values. The apparatus of the fourth aspect further comprises a verification calculator configured to calculate ƒ(u,a) using the obtained function ƒ with the obtained random input number a and a bit string representation u of the obtained predetermined user data as the given input values. The apparatus of the fourth aspect further comprises a verification resolver configured to determine that the alleged cryptographic association between the obtained predetermined user data and the obtained public key is valid in response to the calculated ƒ(u,a) equaling the obtained public exponent E, and to further determine that the alleged cryptographic association between the obtained predetermined user data and the obtained public key is invalid in response to the calculated ƒ(u,a) not equaling the obtained public exponent E.

In an embodiment of the invention, the random derivation of the integer E comprises concatenating the bit string representation u of the given user data and the given random input number a to a bit string; and inputting the concatenated bit string to a substantially one-way hash function to produce a hash value for use as the integer E.

In an embodiment of the invention, the random derivation of the integer E comprises concatenating the bit string representation u of the given user data and the given random input number a to a bit string; inputting the concatenated bit string to a substantially one-way hash function to produce a hash value; and inputting the produced hash value as a seed value to a random number generator to produce a random integer for use as the integer E.

In an embodiment of the invention, a certificate is generated which comprises the generated public key, the given user data having the created cryptographic association with the generated public key, and the given random input number a.

In an embodiment of the invention, the method of the first aspect is performed by a data-processing device controlled by a computer program embodied on a computer readable medium.

In an embodiment of the invention, the method of the second aspect is performed by a data-processing device controlled by a computer program embodied on a computer readable medium.

The invention allows cryptographically associating user data with a public key. More specifically, the invention allows a creator of a key pair—a public and a private key—to associate user data with the public key in such a way that verification data needed to cryptographically verify the association can be made public without compromising the key pair. The user data to be associated may be e.g. identity data related to the owner of the public key in which case the invention allows cryptographically associating a public key and its owner to each other. Therefore, the invention further allows cryptographically verifying that a distributed public key belongs to its alleged owner. Furthermore, the invention allows the above association and verification without use of any third parties.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1a is a flow diagram illustrating a method according to an embodiment of the present invention;

FIG. 1b is a flow diagram illustrating another method according to an embodiment of the present invention; and

FIG. 2 is a block diagram illustrating apparatuses and a certificate according to an embodiment of the present invention.

### DETAILED DESCRIPTION OF THE PREFERRED EMBODIMENTS

Reference will now be made in detail to the embodiments of the invention, examples of which are illustrated in the accompanying drawings.

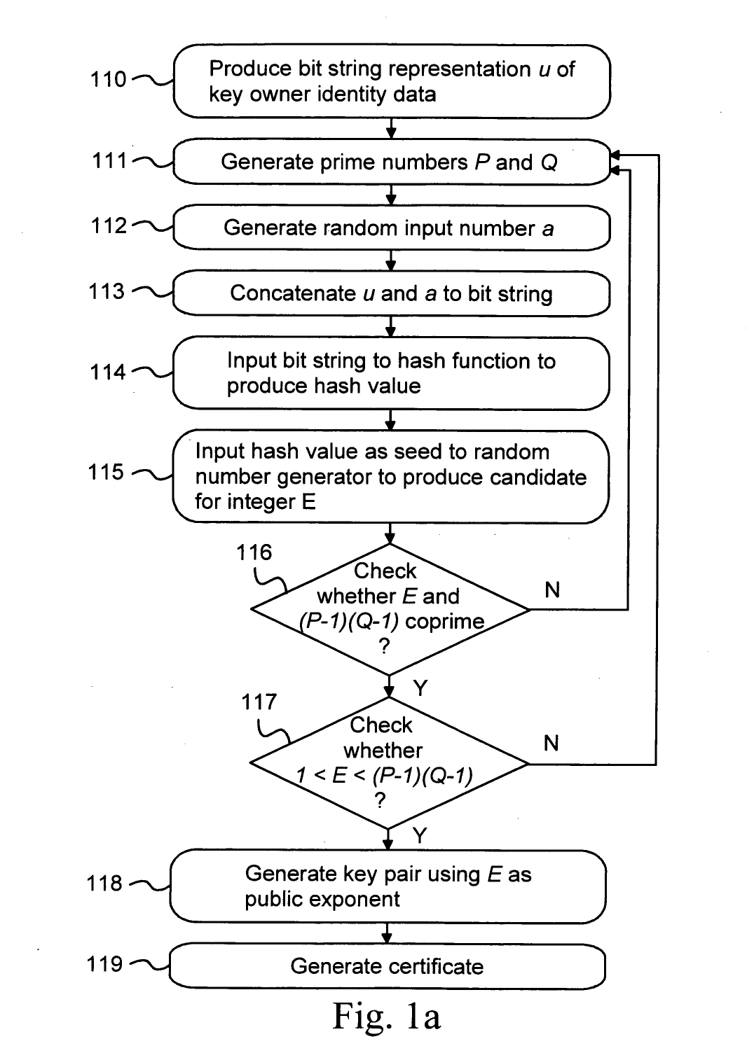

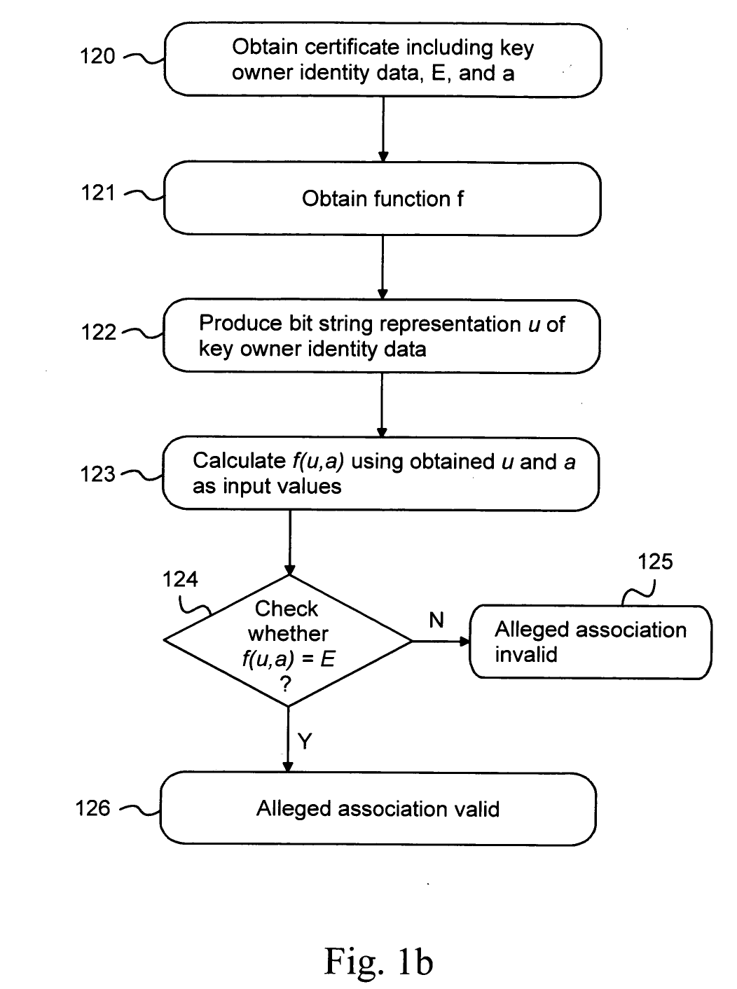

FIG. 1a is a flow diagram that illustrates a method related to cryptographic association of a public key of a cryptographic key pair with given user data according to an embodiment of the present invention.

At step 110, a bit string representation u of given user data is produced. The given user data may comprise e.g. identity data of the owner of the public key and its associated private key, such as name, address, telephone number, and/or electronic mail address, etc. The owner may be e.g. a person, a computer or an organization. However, it is to be understood that the user data does not need to be identity data. Rather, the user data may be any data the creator of the key pair requires to have such a cryptographic association with the public key that can later be cryptographically verified using only such verification data that can be made public without compromising the key pair.

At step 111, a first prime number P and a second prime number Q are generated. In an embodiment, the prime numbers P and Q are large prime numbers, such as 1024-bit prime numbers or larger.

At step 112, a random input number a is generated. Then, steps 113 to 115 are performed in order to produce a candidate value for integer E. If the produced candidate value for integer E passes the checks at steps 116-117, the produced candidate value for integer E will be used as a public exponent in the public key to be generated at step 118. However, if the produced candidate value for integer E fails to pass the checks at least at one of the steps 116-117, the method returns to step 111 to allow producing a new candidate value for integer E.

At first, the bit string representation u of the given user data produced at step 110 and the random input number a generated at step 112 are concatenated to a bit string, step 113. Then, the concatenated bit string is input to a substantially one-way hash function to produce a hash value, step 114. The hash function may be e.g. an MD5 (Message-Digest algorithm 5) function. At step 115, the produced hash value is input as a seed value to a random number generator in order to produce a random integer for use as the integer E. Alternatively, the produced hash value may be used directly as the integer E.

The value for integer E thus derived is a candidate value which may or may not be a final value actually used as the public exponent. To determine which the case is, it is first checked at step 116 whether the produced candidate value for E and the product (P−1)(Q−1) are relatively prime, or coprime. That is, it is checked whether the greatest common divisor of the produced candidate value for E and the product (P−1)(Q−1) is 1.

If the produced candidate value for E and the product (P−1)(Q−1) are found to not be relatively prime, the method returns to step 111 to allow producing a new candidate value for integer E.

Then, it is checked at step 117 whether 1<E<(P−1)(Q−1). If 1<E<(P−1)(Q−1) is not true, then the method returns to step 111 to allow producing a new candidate value for integer E. Consequently, new prime numbers P and Q are generated, and a new candidate value for E is derived using a new random input number a. This loop is repeated until such a candidate value for E is derived that meets the requirements of both the steps 116 and 117.

If also 1<E<(P−1)(Q−1) is true, then the method proceeds to step 118 where a cryptographic key pair is generated. The derived value of E that meets the requirements of both the steps 116 and 117 will be used as the public exponent of the public key of the cryptographic key pair to be generated. The cryptographic key pair may be e.g. an RSA (Rivest, Shamir, Adleman) key pair, in which case the public key will be the pair (PQ, E), and the private key will include at least D, such that D is a multiplicative inverse of E, or DE≡1(mod(P−1)(Q−1)). Accordingly, if the key pair is an RSA key pair, function C=u^{E}modPQ may be used e.g. for encryption, and function u=C^{D}modPQ may be used e.g. for decryption, where C represents the encrypted version of u.

At the optional step 119, a certificate may be generated in order to publish the above generated public key with its associated user data, such as for example key owner identity data. The certificate comprises the above generated public key including the above derived public exponent E. The certificate further comprises the given user data (e.g. the identity data of the owner of the key pair that consists of the public key and its associated private key, as in the example of FIG. 1a) that has the above created cryptographic association with the above generated public key. The certificate further comprises the above generated random input number a. Furthermore, the certificate may be signed with e.g. the above generated private key associated with the above generated public key.

FIG. 1b is a flow diagram that illustrates a method related to verification of a cryptographic association between a public key of a cryptographic key pair and given user data according to an embodiment of the present invention.

First, predetermined user data, and a public key comprising a predetermined public exponent E which public key allegedly has a cryptographic association with the predetermined user data, and a predetermined random input number a that was used in deriving the public exponent E, are obtained, step 120.

The above information may be obtained e.g. by obtaining a certificate which contains them, such as the certificate generated in step 119 of the method of FIG. 1a. In such a case the obtained user data may comprise the identity data of the owner of the cryptographic public key and its associated private key, as discussed above in connection with FIG. 1a.

In addition to the above information contained in the certificate, a predetermined function ƒ that was used to randomly derive the public exponent E from given input values is also obtained, step 121. For example, it may be decided to use a same predetermined function ƒ in each case and to publish this selected function ƒ so that any party can perform the verification of FIG. 1b. The predetermined function ƒ may correspond to e.g. the above discussed steps 113-115 of FIG. 1a.

At step 122, a bit string representation u of the obtained user data is produced. At step 123, ƒ(u,a) is calculated using the bit string representation u of the obtained user data produced at step 122 and the random input number a obtained at step 120 as input values. At step 124, it is checked whether the value calculated at step 123 for ƒ(u,a) equals the public exponent E obtained at step 120.

If the value calculated at step 123 for ƒ(u,a) equals the obtained public exponent E, it is determined that the alleged cryptographic association between the obtained user data and the obtained public key is indeed valid, step 126. If the value calculated at step 123 for ƒ(u,a) does not equal the obtained public exponent E, it is determined that the alleged cryptographic association between the obtained user data and the obtained public key is invalid, step 125.

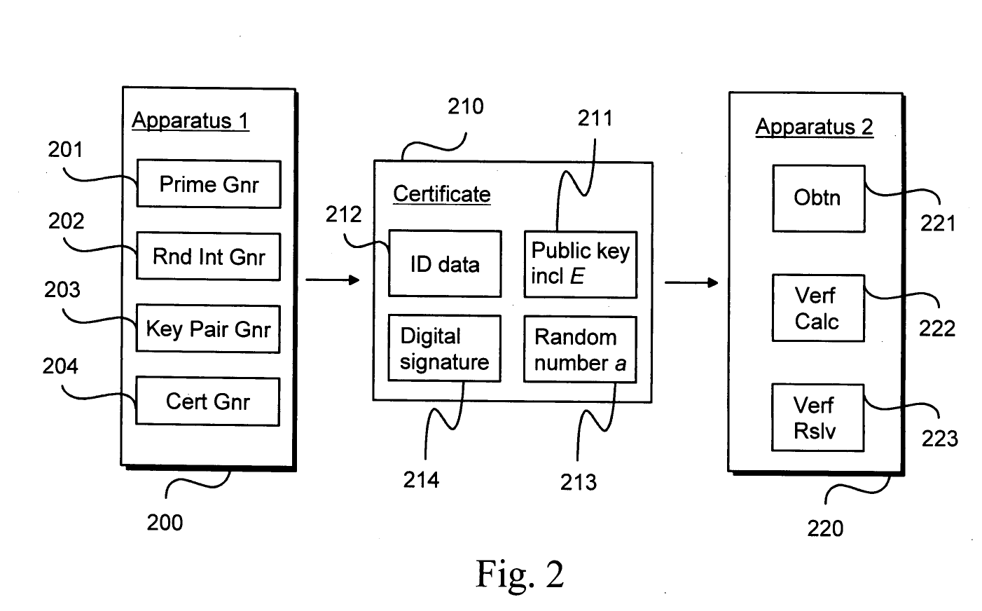

FIG. 2 is a block diagram that illustrates apparatuses and a certificate according to an embodiment of the present invention.

A first apparatus 200 comprises a prime number generator 201 that is configured to generate a first prime number P and a second prime number Q. The first apparatus 200 further comprises a random integer generator 202 that is configured to randomly derive an integer E as a function of a given random input number a and a bit string representation u of given user data.

The first apparatus 200 further comprises a key pair generator 203 that is configured to generate, in response to the derived integer E and a product (P−1)(Q−1) being relatively prime and further in response to the derived integer E both exceeding 1 and remaining below the product (P−1)(Q−1), a cryptographic key pair comprising a private key and an associated public key with the derived integer E used as a public exponent in the public key in order to create a cryptographic association between the public key and the given user data. As discussed above, the given user data may comprise e.g. identity data of the owner of the public key and its associated private key.

In an embodiment, the random integer generator 202 is configured to perform the random derivation of the integer E by concatenating u and a to a bit string, inputting the concatenated bit string to a substantially one-way hash function to produce a hash value, and inputting the produced hash value as a seed value to a random number generator (not illustrated) to produce a random integer for use as the integer E.

In yet another embodiment, the random integer generator 202 is configured to perform the random derivation of the integer E by concatenating u and a to a bit string, and inputting the concatenated bit string to a substantially one-way hash function to produce a hash value for use as the integer E.

The first apparatus 200 further comprises an optional certificate generator 204 that is configured to generate a certificate 210 comprising the public key 211 including the derived public exponent E, the given user data 212 having the created cryptographic association with the generated public key 211, the generated random input number a 213, and optionally a digital signature 214 produced e.g. with a private key associated with the public key 211.

A second apparatus 220 comprises an obtainer 221 that is configured to obtain predetermined user data (which may be the given user data 212 included in the certificate 210), a public key (which may be the public key 211 included in the certificate 210) comprising a predetermined integer E as its public exponent which public key allegedly has a cryptographic association with the obtained user data, a predetermined random input number a (which may be the random input number 213 included in the certificate 210) used in deriving the public exponent E, and a predetermined function ƒ used to derive the public exponent E from given input values.

The second apparatus 220 further comprises a verification calculator 222 configured to calculate ƒ(u,a) using the obtained function ƒ with the obtained random input number a and a bit string representation u of the obtained user data as the given input values.

The second apparatus 220 further comprises a verification resolver 223 configured to determine that the alleged cryptographic association between the obtained user data and the obtained public key is valid in response to the calculated value for ƒ(u,a) equaling the obtained public exponent E. Furthermore, the verification resolver 223 is configured to determine that the alleged cryptographic association between the obtained user data and the obtained public key is invalid in response to the calculated value for ƒ(u,a) not equaling the obtained public exponent E.

The exemplary embodiments can include, for example, any suitable servers, workstations, personal computers, laptop computers, personal digital assistants, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network, Packet Data Networks, the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. Further, the exemplary embodiments can be implemented on the World Wide Web. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A method comprising:
generating a first prime number P and a second prime number Q;
randomly deriving an integer E as a function of a given random input number a and a bit string representation u of given user data; and
generating, in response to the derived integer E and a product (P−1)(Q−1) being relatively prime and further in response to the derived integer E both exceeding 1 and remaining below the product (P−1)(Q−1), a cryptographic key pair comprising a private key and an associated public key with the derived integer E used as a public exponent in the public key in order to create a cryptographic association between the public key and the given user data.

2. The method according to claim 1, wherein the random derivation of the integer E comprises:
concatenating the bit string representation u of the given user data and the given random input number a to a bit string; and
inputting the concatenated bit string to a substantially one-way hash function to produce a hash value for use as the integer E.

3. The method according to claim 1, wherein the random derivation of the integer E comprises:
concatenating the bit string representation u of the given user data and the given random input number a to a bit string;
inputting the concatenated bit string to a substantially one-way hash function to produce a hash value; and
inputting the produced hash value as a seed value to a random number generator to produce a random integer for use as the integer E.

4. The method according to claim 1, further comprising generating a certificate comprising the generated public key, the given user data having the created cryptographic association with the generated public key, and the given random input number a.

5. The method according to claim 1, wherein the method is performed by a data-processing device controlled by a computer program embodied on a computer readable medium.

6. A method comprising:
obtaining predetermined user data, a public key of a cryptographic key pair comprising a predetermined integer E as a public exponent and allegedly having a cryptographic association with the predetermined user data, a predetermined random input number a, and a predetermined function ƒ used to randomly derive the obtained public exponent E from given input values;
calculating ƒ(u,a) using the obtained function ƒ with the obtained random input number a and a bit string representation u of the obtained predetermined user data as the given input values;
determining that the alleged cryptographic association between the obtained predetermined user data and the obtained public key is valid in response to the calculated ƒ(u,a) equaling the obtained public exponent E; and
determining that the alleged cryptographic association between the obtained predetermined user data and the obtained public key is invalid in response to the calculated ƒ(u,a) not equaling the obtained public exponent E.

7. The method according to claim 6, wherein the method is performed by a data-processing device controlled by a computer program embodied on a computer readable medium.

8. An apparatus comprising:
a prime number generator configured to generate a first prime number P and a second prime number Q;
a random integer generator configured to randomly derive an integer E as a function of a given random input number a and a bit string representation u of given user data; and
a key pair generator configured to generate, in response to the derived integer E and a product (P−1)(Q−1) being relatively prime and further in response to the derived integer E both exceeding 1 and remaining below the product (P−1)(Q−1), a cryptographic key pair comprising a private key and an associated public key with the derived integer E used as a public exponent in the public key in order to create a cryptographic association between the public key and the given user data.

9. The apparatus according to claim 8, wherein the random integer generator is configured to perform the random derivation of the integer E by concatenating the bit string representation u and the given random input number a to a bit string, and inputting the concatenated bit string to a substantially one-way hash function to produce a hash value for use as the integer E.

10. The apparatus according to claim 8, wherein the random integer generator is configured to perform the random derivation of the integer E by concatenating the bit string representation u and the given random input number a to a bit string, inputting the concatenated bit string to a substantially one-way hash function to produce a hash value, and inputting the produced hash value as a seed value to a random number generator to produce a random integer for use as the integer E.

11. The apparatus according to claim 8, further comprising a certificate generator configured to generate a certificate comprising the generated public key, the given user data having the created cryptographic association with the generated public key, and the given random input number a.

12. An apparatus comprising:
an obtainer configured to obtain predetermined user data, a public key of a cryptographic key pair comprising a predetermined integer E as a public exponent and allegedly having a cryptographic association with the predetermined user data, a predetermined random input number a, and a predetermined function ƒ used to randomly derive the obtained public exponent E from given input values;
a verification calculator configured to calculate ƒ(u,a) using the obtained function ƒ with the obtained random input number a and a bit string representation u of the obtained predetermined user data as the given input values; and
a verification resolver configured to determine that the alleged cryptographic association between the obtained predetermined user data and the obtained public key is valid in response to the calculated ƒ(u,a) equaling the obtained public exponent E, and to determine that the alleged cryptographic association between the obtained predetermined user data and the obtained public key is invalid in response to the calculated ƒ(u,a) not equaling the obtained public exponent E.

13. An apparatus comprising:
generating means for generating a first prime number P and a second prime number Q;
deriving means for randomly deriving an integer E as a function of a given random input number a and a bit string representation u of given user data; and
generating means for generating, in response to the derived integer E and a product (P−1)(Q−1) being relatively prime and further in response to the derived integer E both exceeding 1 and remaining below the product (P−1)(Q−1), a cryptographic key pair comprising a private key and an associated public key with the derived integer E used as a public exponent in the public key in order to create a cryptographic association between the public key and the given user data.

14. An apparatus comprising:
obtaining means for obtaining predetermined user data, a public key of a cryptographic key pair comprising a predetermined integer E as a public exponent and allegedly having a cryptographic association with the predetermined user data, a predetermined random input number a, and a predetermined function ƒ used to randomly derive the obtained public exponent E from given input values;
calculating means for calculating ƒ(u,a) using the obtained function ƒ with the obtained random input number a and a bit string representation u of the obtained predetermined user data as the given input values;
determining means for determining that the alleged cryptographic association between the obtained predetermined user data and the obtained public key is valid in response to the calculated ƒ(u,a) equaling the obtained public exponent E; and
determining means for determining that the alleged cryptographic association between the obtained predetermined user data and the obtained public key is invalid in response to the calculated ƒ(u,a) not equaling the obtained public exponent E.
